(19) United States
(12) Patent Application Publication
(10) Pub. No.: US 2026/0020007 A1
(43) Pub. Date: Jan. 15, 2026

(54) TIME RESTRICTION AND CPU OCCUPATION OF TIME DOMAIN CHANNEL PROPERTY (TDCP) REPORTING METHOD

(71) Applicant: ZTE Corporation, Shenzhen (CN)

(72) Inventors: Guangyu JIANG, Shenzhen (CN); Bo GAO, Shenzhen (CN); Minqiang ZOU, Shenzhen (CN); Ke YAO, Shenzhen (CN)

(21) Appl. No.: 19/338,968

(22) Filed: Sep. 24, 2025

Related U.S. Application Data
(63) Continuation of application No. PCT/CN2023/087114, filed on Apr. 7, 2023.

(51) Int. Cl. H04W 72/0446; H04L 5/00

(52) U.S. Cl. CPC H04W 72/0446; H04L 5/0048

(57) ABSTRACT

This patent application discloses methods, apparatus, and systems related to time restriction and CPU occupation of time-domain channel property (TDCP) reporting. In one example aspect, a method for wireless communication includes reporting, by a wireless device, a time-domain channel property to a network device in a time slot n, wherein the time-domain channel property is measured based on a plurality of Tracking Reference Signal (TRS) occasions determined based 1) a CSI report setting, or 2) a CSI reference resource.

### CROSS-REFERENCE TO RELATED APPLICATION

This application is a continuation and claims priority to International Application No. PCT/CN2023/087114, filed on Apr. 7, 2023, the disclosure of which is hereby incorporated by reference herein in its entirety.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to time restriction and SCI Processing Unit (CPU) occupation of time-domain channel property (TDCP) reporting methods in a wireless communication network.

In one example aspect, a wireless communication method is disclosed. The method includes reporting, by a wireless device, a time-domain channel property to a network device in a time slot n, wherein the time-domain channel property is measured based on a plurality of Tracking Reference Signal (TRS) occasions determined based 1) a CSI report setting, or 2) a CSI reference resource.

In another example aspect, another wireless communication method is disclosed. The method includes receiving, by a network device, a time-domain channel property from a wireless device, wherein the time-domain channel property is measured based on a plurality of Tracking Reference Signal (TRS) determined based on 1) a CSI report setting, and 2) a CSI reference resource.

In another example aspect, another wireless communication method is disclosed. The method includes transmitting, by a wireless device to a network node, a time-domain channel property (TDCP) report determined by a group of Tracking Reference Signal (TRS) occasions.

In another example aspect, another wireless communication method is disclosed. The method includes receiving, by a network node from a wireless device, a time-domain channel property (TDCP) report determined by a group of Tracking Reference Signal (TRS) occasions; and conducting an operation based on the TDCP report.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows an example diagram of high-speed railway scenario.

FIG. 2 shows an example diagram indicating the timeline of aperiodic CSI reporting.

FIG. 3 shows an example diagram indicating the CPU occupation time of a TDCP report.

FIG. 4 shows an example diagram indicating the CPU occupation time of a TDCP report.

FIG. 5 shows an example diagram indicating the CPU occupation time of a TDCP report.

FIG. 6 shows an example of a block diagram of a hardware platform that may be a part of a network device or a communication device, per some embodiments of the present document.

FIG. 7 shows an example of network communication, including a network device (BS) and wireless device based on some implementations of the disclosed technology.

FIGS. 8-11 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example and the disclosed techniques are applicable to other wireless protocols also.

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale. In should be noted, in the disclosure of this patent application, a network node can be at least one of a Location Management Function (LMF), a Base Station (BS) (e.g., gNB, and/or transmission reception point TRP), or a core network.

Note that, in this patent, “UE” is equivalent to a wireless communication device.

Note that, in this patent, “BS” is equivalent to a wireless network device, the next Generation Node B (gNB), or TRP.

Note that, in this patent, “Reference Signal (RS)” is equivalent to CSI-RS, RS for Tracking or Tracking RS (TRS).

Note that, in this patent, “CSI report configuration signaling” is equivalent to higher-level signaling, Radio Resource Control (RRC), Radio Resource Management (RRM), Radio Resource Arrangement (RRA), Downlink Control Information (DCI), or Physical Down-link Control Channel (PDCCH).

Note that, in this patent, “TDCP” is equivalent to CSI.

Notes that, in this patent, “time unit” can be a sub-symbol, symbol, slot, sub-frame, frame, or transmission occasion.

In this patent, “channel correlation” is equivalent to correlation, auto-correlation, correlation coefficient, channel auto-correlation, and channel correlation coefficient.

Note that, in this patent, a “TRS burst” is defined as an occasion of all the two/four CSI-RS resources in the TRS resource set.

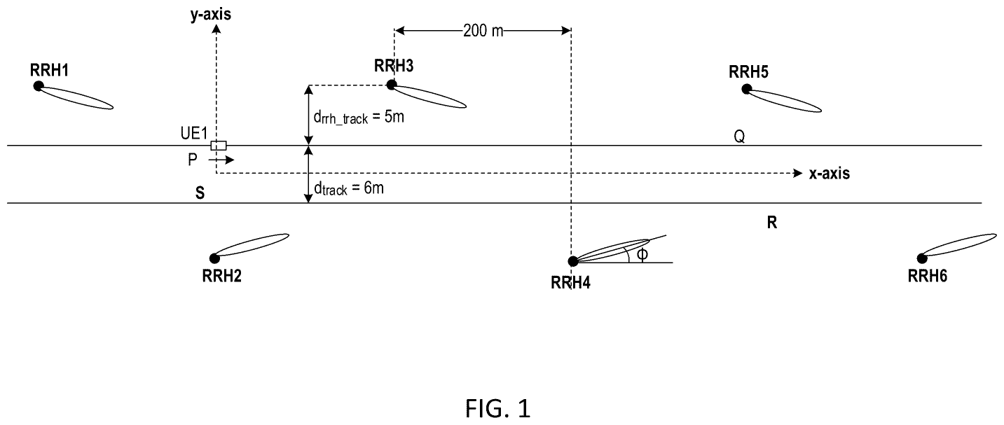

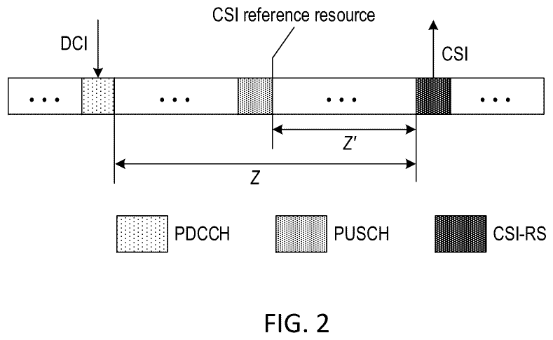

TDCP is one type of CSI indicating the changing speed of the channel between UE and BS. TDCP is typically applied in two scenarios: the high-speed railway scenario and the expressway scenario. The high-speed-railway scenario is illustrated in FIG. 1, where there are 6 Remote Radio Heads (RRH). In order to save the handover procedure, some of the RRHs correspond to the same cell. That means that there is a long narrow cell along with a railway. Similarly, several Transmission/Reception Points (TRP) are deployed alone with an expressway.

Generally, TDCP comprises one or multiple amplitude(s) and/or phase(s) of channel correlation(s). The channel correlation c(τ) is measured through a special kind of CSI-RS named TRS, for which two or four CSI-RS resources are configured within two consecutive slots. Detailed specifications of TRS can be found in [clause 5.1.6.1.1 TS 38.214].

However, under the existing standard, the specific TDCP measurement and reporting procedure, including time restriction and CPU occupation of TDCP reporting, have not been determined yet. The proposed methods are beneficial at least for proposing applicable time restrictions and CPU occupation schemes for TDCP reporting. The systems and methods discussed herein can include processes, procedures, and/or implementations for signaling.

The example embodiments disclosed herein are directed to solving the issues relating to one or more of the problems presented in the prior art, as well as providing additional features that will become readily apparent by reference to the following detailed description when taken in conjunction with the accompanying drawings. In accordance with various embodiments, example systems, methods, devices and computer program products are disclosed herein. It is understood, however, that these embodiments are presented by way of example and are not limiting, and it will be apparent to those of ordinary skill in the art who read the present document that various modifications to the disclosed embodiments can be made while remaining within the scope of this disclosure.

### Embodiment 0 (Initial Discussion)

TDCP report is one kind of aperiodic CSI report. The general measurement and reporting procedure of TDCP is like follows:
UE receives higher layer signaling;
UE receives a DCI triggering a TDCP report;
UE measures TDCP through TRS transmitted from BS.

A TDCP report comprises the following quantities:
Y≥1 amplitudes of channel correlations;
Y≥1 phases of channel correlations if the higher layer parameter “PhaseReport” is configured as “on”.

The channel correlation ϵ(T) can be measured by a pair of TRS occasions with an inter-occasion interval of τ. The computation formula of c(τ) is

$$c ( τ ) = \frac{\vert {\sum }_{n = 0}^{N - 1} {h}_{n} ( t + τ ) \cdot {h}_{n}^{*} ( t ) \vert}{\sqrt{{\sum }_{n} {\vert {h}_{n} ( t + τ ) \vert}^{2}} \sqrt{{\sum }_{n} {\vert {h}_{n} ( t ) \vert}^{2}}}$$

where t denotes time delay or lag, hₙ(t) denotes the channel response for subcarrier n measured by the TRS occasion at time t, and (·) * denotes conjugate operation. The formula shows that the amplitude of channel correlation has been normalized.

UE reports TDCP to BS through the PUSCH indicated by DCI

### Embodiment 1: Time Restriction of TDCP Reporting

The definition of CSI reference resource is given in [5 TS 38.214] as follows:
In the frequency domain, the CSI reference resource is defined by the group of downlink physical resource blocks corresponding to the band to which the derived CSI relates.
In the time domain, the CSI reference resource for a CSI reporting in uplink slot n′ is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by a higher layer as specified in clause 4.2 of [6 TS 38.213], and where μk_{offset} is the subcarrier spacing configuration for K_{offset} with a value of 0 for frequency range 1,

$$where n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} ) - ( \frac{{N}_{slot , offset , DL}^{CA}}{{2}^{{μ}_{offset , DL}}} ) \cdot {2}^{{μ}_{DL}} ⌋ \qquad [ 42 ]$$

and μ_{DL}, μ_{UL} are the subcarrier spacing configurations for DL and UL, respectively, and N^{CA}_{slot,offset} and μ_{offset} are determined by higher-layer configured ca-SlotOffset for the cells transmitting the uplink and downlink, as defined in clause 4.5 of [4, TS 38.211]
where for aperiodic CSI reporting, if the UE is indicated by the DCI to report CSI in the same slot as the CSI request, n_{CSI_ref} is such that the reference resource is in the same valid downlink slot as the corresponding CSI request, otherwise n_{CSI_ref} is the smallest value greater than or equal to

$$⌊ {Z}^{′} / {N}_{symb}^{slot} ⌋$$

such that slot n-n_{CSI_ref} corresponds to a valid downlink slot, where Z′ corresponds to the delay requirement as defined in Clause 5.4.

The definitions of Z and Z′ are given in [5, TS 38.214] as follows:

When the CSI request field on a DCI triggers a CSI report(s) on PUSCH, the UE shall provide a valid CSI report for the n-th triggered report,
if the first uplink symbol to carry the corresponding CSI report(s) including the effect of the timing advance, starts no earlier than at symbol Z_{ref}, and
if the first uplink symbol to carry the n-th CSI report including the effect of the timing advance, starts no earlier than at symbol Z′_{ref}(n),
where Z_{ref} is defined as the next uplink symbol with its CP starting T_{m.es}=(Z)(2048+144)·κ2^{-μ}·T_{c}+T after the end of the last symbol of the PDCCH triggering the CSI report(s), and where Z′_{ref}(n), is defined as the next uplink symbol with its CP starting T′_{CS}=(Z)(2048+14)·κ2^{-μ}·T_{C} after the end of the last symbol in time of the latest of: aperiodic CSI-RS resource for channel measurements, aperiodic CSI-IM used for interference measurements, and aperiodic NZP (non-zero power) CSI-RS for interference measurement.

For TDCP, if the CSI report setting is associated with one or two aperiodic TRS(s):
If the higher layer parameter time RestictionForChannelMeasurement is set to “notConfigured”, UE shall derive the channel measurements for computing TDCP reported in uplink slot n base on only the occasions of TRS(s) no later than the CSI reference resource, associated with the CSI resource setting(s);
If the higher layer parameter time RestictionForChannelMeasurement is set to “Configured”, UE shall derive the channel measurements for computing TDCP reported in uplink slot n based on only one pair of TRS occasions, wherein the last TRS occasion in the TRS occasion pair is the most recent, no later than the CSI reference resource, occasion of TRS(s) associated with the CSI resource setting(s).

For a TDCP report, if the CSI report setting is associated with one periodic TRS and one aperiodic TRS

If the higher layer parameter time RestictionForChannelMeasurement is set to “notConfigured”, UE shall derive the channel measurements for computing TDCP reported in uplink slot n based on only.

Occasions of aperiodic TRS, no later than the CSI reference resource, associated with the aperiodic CSI resource setting.

Occasions of periodic TRS, before the occasions of aperiodic TRS, are associated with the periodic CSI resource setting. The occasions of periodic TRS should be after the last symbol of PDCCH, triggering the TDCP report

If the higher layer parameter timeRestictionForChannelMeasurement is set to “Configured”, UE shall derive the channel measurements for computing TDCP reported in uplink slot n based on only one pair of TRS occasions, wherein the last TRS occasion in the TRS occasion pair is the most recent, no later than the CSI reference resource, occasion of aperiodic TRS associated with the aperiodic CSI resource setting.

The first TRS occasion in the TRS occasion pair is an occasion of periodic TRS before the aperiodic TRS occasion associated with the periodic CSI resource setting. The occasion of periodic TRS should be later than the last symbol of PDCCH triggering the TDCP report.

For a TDCP report, if the CSI report setting is associated with one periodic TRS with a periodicity of T1 and Y-1 periodic TRSs with the same periodicity of T2, where T1 is an integer multiple of T2.

If the higher layer parameter time RestictionForChannelMeasurement is set to “notConfigured”, UE shall derive channel measurements for computing TDCP reported in uplink slot n based on only

Occasions of the TRS with the periodicity of T2, no later than the CSI reference resource, associated with the CSI resource setting, and

Occasions of the TRS with the periodicity of T1, before the occasions of the TRS with shorter periodicity, associated with the CSI resource setting

These occasions of TRS should be later than the last symbol of the PDCCH, triggering the TDCP report

If the higher layer parameter timeRestictionForChannelMeasurement is set to “notConfigured”, UE shall derive channel measurements for computing each channel correlation in the TDCP reported in uplink slot n based on only one pair of TRS occasions, wherein the last TRS occasion in the TRS occasion pair is the most recent, no later than the CSI reference resource, an occasion of the TRS with the periodicity of T2 associated with the CSI resource setting(s).

The first TRS occasion in the TRS occasion pair is an occasion of the TRS with the periodicity of T1, before the occasion of the TRS with longer periodicity, associated with the CSI resource setting(s).

This pair of TRS occasions should be later than the last symbol of the PDCCH triggering the TDCP report.

For a TDCP report, if the CSI report setting is associated with one periodic TRS or multiple periodic TRSs with a same periodicity.

If the higher layer parameter time RestictionForChannelMeasurement is set to “notConfigured”, UE shall derive the channel measurements for computing TDCP reported in uplink slot n based on only.

The occasions of TRS(s), no later than the CSI reference resource, associated with the CSI resource setting(s).

These occasions of TRS(s) should be later than the last symbol of PDCCH triggering the TDCP report.

If the higher layer parameter timeRestictionForChannelMeasurement is set to “Configured”, UE shall derive the channel measurements for computing each channel correlation in the TDCP reported in uplink slot n based on only one pair of TRS occasions, wherein the last TRS occasion in the TRS occasion pair should be the most recent, no later than the CSI reference resource, occasion of TRS associated with the CSI resource setting(s).

The first TRS occasion in the TRS occasion pair should be later than the last symbol of PDCCH triggering the TDCP report, associated with the CSI resource setting(s)

For a TDCP report, the Z and Z′ are determined by one of the following methods:

Z and Z′ are defined as (Z₂, Z₂), where (Z₂, Z₂) are defined in Table 5.4-2 in [5 TS 38.214].

Z and Z′ are defined as (Z₂+V, Z₂+V), where Vis a constant value whose candidate values are {1, 2, . . . , 100}.

Z and Z′ are determined by Z₂, Z₂, and Q according to the formula (Z, Z′)= (Z₂+Q, Z₂+Q), where Q is a UE capability.

Z and Z′ are determined by Z₂, Z₂, Y, and T, according to the formula (Z, Z′)= (Z₂+YT, Z₂), where Y is the number of amplitudes and/or phases of channel correlations in a TDCP report, and the delays corresponding to the Y channel correlations are {1, 21, . . . , YT}.

Z and Z′ are determined by Z₂, Z₂, Y, t, and Q, according to the formula (Z, Z′)= (Z₂+Y_{τ}+Q, Z₂+Q).

Z and Z′ are determined by Z₂, Z₂, Y, t, and X, where X is the number of slots within a TRS burst, according to one of the following formulas:

$$( Z , {Z}^{′} ) = ( {Z}_{2} + Y τ + ( X - 1 ) \cdot {N}_{symb}^{slot} , {Z}_{2}^{′} )$$

$$( Z , {Z}^{′} ) = ( {Z}_{2} + Y τ + ( X - 1 ) \cdot {N}_{symb}^{slot} + 4 , {Z}_{2}^{′} )$$

Z and Z′ are determined by Z₂, Z₂, Y, τ, X, and Q, according to one of the following formulas:

$$( Z , {Z}^{′} ) = ( {Z}_{2} + Y τ + ( X - 1 ) \cdot {N}_{symb}^{slot} + Q , {Z}_{2}^{′} + Q )$$

$$( Z , {Z}^{′} ) = ( {Z}_{2} + Y τ + ( X - 1 ) \cdot {N}_{symb}^{slot} + 4 + Q , {Z}_{2}^{′} + Q )$$

TABLE 1
Z₂ and Z′_{2 are} defined in [5 TS 38.214]

Z₂ [symbols]

| μ | Z₂ | Z′₂ |
|---|---|---|
| 0 | 40 | 37 |
| 1 | 72 | 69 |
| 2 | 141 | 140 |
| 3 | 152 | 140 |
| 5 | 608 | 560 |
| 6 | 1216 | 1120 |

### Embodiment 2: CPU Occupation of TDCP Reporting

A TDCP occupies a number of CPU(s) for one or multiple time duration(s) by one of the following methods:

A TDCP report occupies CPU(s) for only one continuous time duration

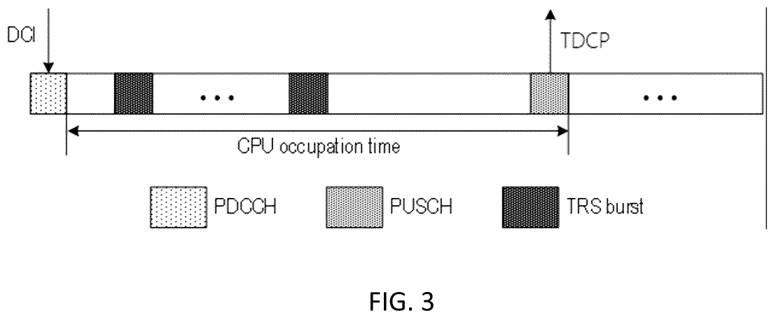

A TDCP report occupies CPU(s) from the first symbol after the PDCCH carrying the DCI triggering the TDCP report until the last symbol of the scheduled PUSCH carrying the TDCP report. The CPU occupation time is illustrated in FIG. 3.

The number of CPU(s) O_{CPU} occupied by a TDCP report is determined by one of the following methods:

$${O}_{CPU} = 1$$

O_{CPU} is determined by UE capability K, i.e., O_{CPU}=K

O_{CPU} is determined by Y, according to one of the following formulas:

$$\begin{matrix}{O}_{CPU} = Y ; \\ {O}_{CPU} = Y + 1 ; \\ {O}_{CPU} = ceil [ Y / 2 ] ) ; \\ {O}_{CPU} = ceil [ ( Y + 1 ) / 2 ] ) ; \\ {O}_{CPU} = ceil [ Y / 4 ] ) ; \\ {O}_{CPU} = ceil [ ( Y + 1 ) / 4 ] ) .\end{matrix}$$

O_{CPU} is determined by Y and UE capability K, according to one of the following formulas:

$$\begin{matrix}{O}_{CPU} = ceil [ Y / K [ ) ; \\ {O}_{CPU} = ceil [ ( Y + 1 ) / K ] ) .\end{matrix}$$

O_{CPU} is determined by Y and M, where M is the number of TRS occasion pairs used to derive each channel correlation in a TDCP report, according to one of the following formulas:

$$\begin{matrix}{O}_{CPU} = ceil [ YM / 2 ] ) ; \\ {O}_{CPU} = ceil [ YM / 4 ] ) ; \\ {O}_{CPU} = ceil [ ( Y + 1 ) M / 2 ] ) ; \\ {O}_{CPU} = ceil [ ( Y + 1 ) M / 4 ] ) .\end{matrix}$$

O_{CPU} is determined by Y, M, and UE capability K, according to one of the following formulas:

$$\begin{matrix}{O}_{CPU} = ceil [ Y M / K ] ) ; \\ {O}_{CPU} = ceil [ ( Y + 1 ) M / K ] ) .\end{matrix}$$

A TDCP report occupies CPU(s) for multiple (possibly partially overlapping) time durations by one of the following methods:

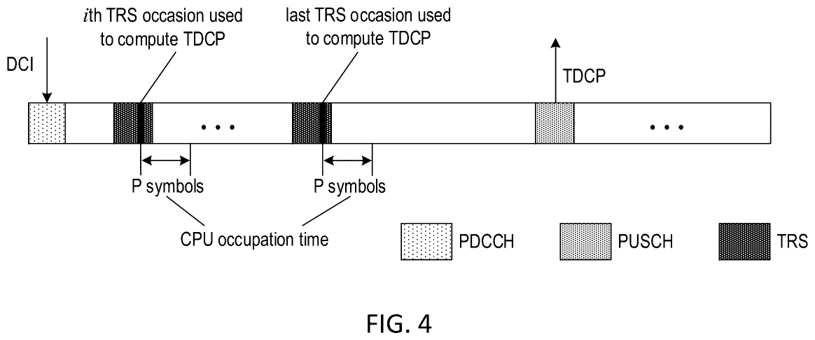

Each TRS occasion used to derive the channel measurement for computing TDCP occupies CPU(s) from the TRS occasion symbol until P symbols after the TRS occasion symbol. The CPU occupation time is illustrated in FIG. 4.

Candidate values of P are {5, 6, . . . , 20}.

The CPU(s) number O_{CPU} occupied by each TRS occasion used to drive the channel measurements for computing TDCP is determined by one of the following methods:

$${O}_{CPU} = 1 ;$$

O_{CPU} is determined by UE capability K, i.e., O_{CPU}=K.

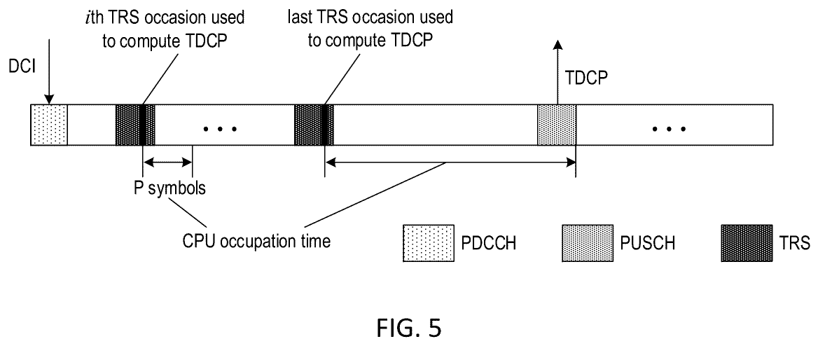

Each TRS occasion, except the last one, used to derive the channel measurements for computing TDCP occupies CPU(s) from the TRS occasion symbol until P symbols after the TRS occasion symbol; the last TRS occasion used to derive the channel measurements for computing TDCP occupies CPU(s) from the TRS occasion symbol until the last symbol of the configured PUSCH carrying the TDCP report. The CPU occupation time is illustrated in FIG. 5.

Candidate values of P are {5, 6, . . . , 20}.

Each TRS occasion, except the last one, used to drive the channel measurements for computing TDCP, occupies O_{CPU}=1 CPU

The CPU(s) number O_{CPU} occupied by the last TRS occasion, used to drive the channel measurements for computing TDCP, is determined by one of the following methods:

$${O}_{CPU} = 1 ;$$

O_{CPU} is determined by UE capability K, i.e., O_{CPU}=K.

O_{CPU} is determined by Y, according to one of the following formulas:

$$\begin{matrix}{O}_{CPU} = Y ; \\ {O}_{CPU} = ceil ( Y / 2 ) ; \\ {O}_{CPU} = ceil ( Y / 4 ) .\end{matrix}$$

O_{CPU} is determined by Y and UE capability K, according to one of the following formulas:

$$\begin{matrix}{O}_{CPU} = ceil ( Y / K ) ; \\ {O}_{CPU} = ceil [ ( Y + 1 ) / K ] .\end{matrix}$$

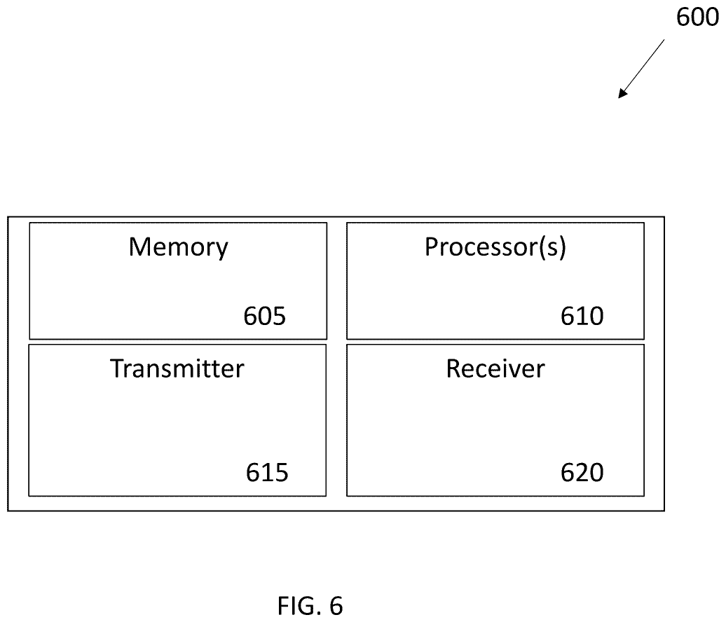

FIG. 6 shows an exemplary block diagram of a hardware platform 600 that may be a part of a network device (e.g., base station) or a communication device (e.g., user equipment (UE)). The hardware platform 600 includes at least one processor 610 and a memory 605 having instructions stored thereupon. The instructions upon execution by the processor 610 configure the hardware platform 600 to perform the operations described in FIG. 6 and in the various embodiments described in this patent application document. The transmitter 615 transmits or sends information or data to another device. For example, a network device transmitter can send a message to user equipment. The receiver 620 receives information or data transmitted or sent by another device. For example, user equipment can receive a message from a network device.

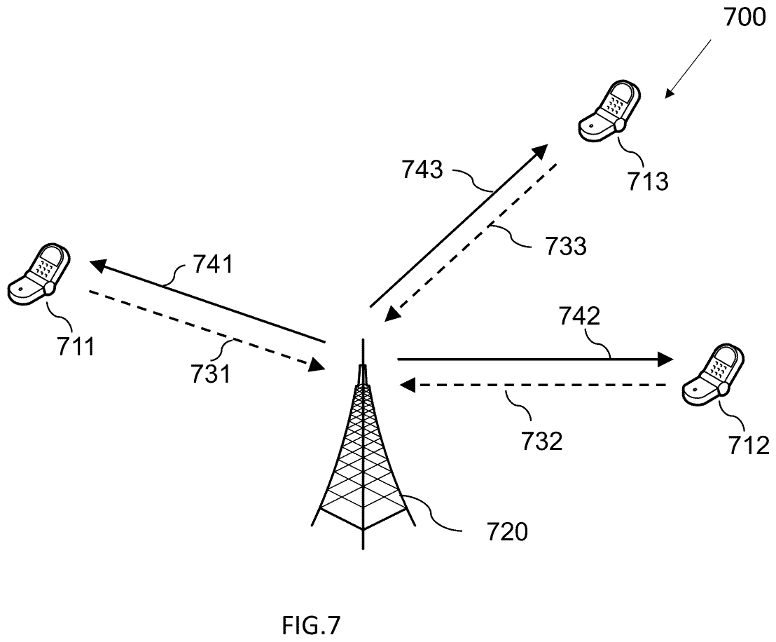

The implementations as discussed above will apply to a network communication. FIG. 7 shows an example of a communication system (e.g., a 6G or NR cellular network) that includes a base station 720 and one or more user equipment (UE) 711, 712 and 713. In some embodiments, the UEs access the BS (e.g., the network) using a communication link to the network (sometimes called uplink direction, as depicted by dashed arrows 731, 732, 733), which then enables subsequent communication (e.g., shown in the direction from the network to the UEs, sometimes called downlink direction, shown by arrows 741, 742, 743) from the BS to the UEs. In some embodiments, the BS send information to the UEs (sometimes called downlink direction, as depicted by arrows 741, 742, 743), which then enables subsequent communication (e.g., shown in the direction from the UEs to the BS, sometimes called uplink direction, shown by dashed arrows 731, 732, 733) from the UEs to the BS. The UE may be, for example, a smartphone, a tablet, a mobile computer, a machine to machine (M2M) device, an Internet of Things (IoT) device, and so on.

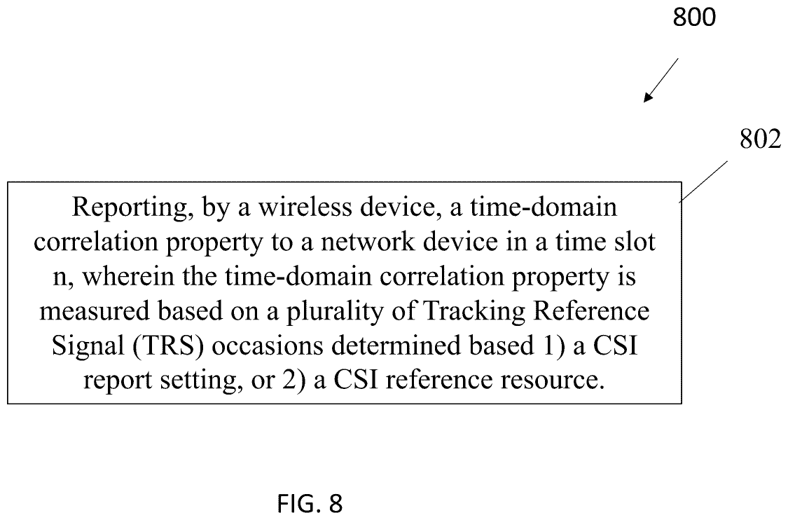

Some preferred embodiments are not described. In one example aspect (e.g., as depicted in FIG. 8), a wireless communication method is disclosed. The method includes reporting (802), reporting, by a wireless device, a time-domain channel property to a network device in a time slot n, wherein the time-domain channel property is measured based on a plurality of Tracking Reference Signal (TRS) occasions determined based 1) a CSI report setting, or 2) a CSI reference resource.

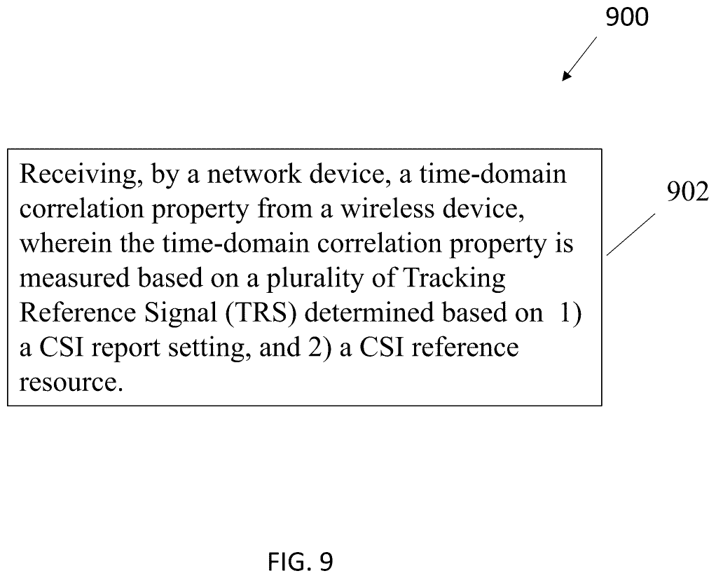

In another example aspect (e.g., as depicted in FIG. 9), another wireless communication method is disclosed. The method includes receiving (902), by a network device, a time-domain channel property from a wireless device, wherein the time-domain channel property is measured based on a plurality of Tracking Reference Signal (TRS) determined based on 1) a CSI report setting, and 2) a CSI reference resource.

In some embodiments, the method further comprising receiving, by a wireless device, a Downlink Control Information (DCI) indicating the CSI report setting, from a network device, wherein the CSI report setting is associated with a CSI resource setting and comprises a parameter timeRestrictionForChannelMeasurements; receiving, by the wireless device, TRS, from a network device; and measuring, by the wireless device, a time-domain channel property comprising at least one of: an amplitude and a phase of a plurality of channel correlation, to the network device, wherein each of the plurality of channel correlation is determined based on a plurality of TRS occasion determined based on 1) the CSI report setting, and 2) a CSI reference resource.

In some embodiments, when the CSI report setting is associated with one or more aperiodic CSI resource settings: when the parameter timeRestrictionForChannelMeasurements comprised in the CSI report setting is set to “notConfigured”, the plurality of TRS occasion is selected from the plurality of TRS occasions associated with the one or two aperiodic CSI resource setting, wherein the plurality of TRS occasions are no later than the CSI reference resource in time domain; and when the parameter time RestrictionForChannelMeasurements comprised in the CSI report setting is set to “Configured”, the plurality of TRS occasions contains a first TRS occasion and a second TRS occasion that is after the first TRS occasion, wherein the plurality of TRS occasion is selected from the plurality of TRS occasion associated with the one or more aperiodic CSI resource settings, and the plurality of TRS occasion is no later than the CSI reference resource.

In some embodiments, the second TRS occasion is a closest slot to slot n and no later than the CSI reference resource in time domain.

In some embodiments, when the CSI report setting is associated with a periodic CSI resource setting and an aperiodic CSI resource setting: when the parameter timeRestrictionForChannelMeasurements comprised in the CSI report setting is set to “notConfigured”, the plurality of TRS occasion is selected from a first group of TRS occasions associated with the aperiodic CSI resource setting and a second group of TRS occasions associated with the periodic CSI resource setting, wherein the plurality of TRS occasion is no later than the CSI reference resource and the second group of TRS occasion is before the first group of TRS occasions; and when the parameter timeRestrictionForChannelMeasurements comprised in the CSI report setting is set to “Configured”, the plurality of TRS occasions comprises a first TRS occasion selected from the group of TRS occasion associated with the periodic CSI resource setting and a second TRS occasion selected from the group of TRS occasion associated with the aperiodic CSI resource setting, wherein the second TRS occasion is after the first TRS occasion, and the plurality of TRS occasion is no later than the CSI reference resource.

In some embodiments, the second TRS occasion is closest to slot n and no later than the CSI reference resource in time domain.

In some embodiments, the plurality of TRS occasions are after a last symbol of a Physical Downlink Control Channel (PDCCH) signaling.

In some embodiments, when the CSI report setting is associated with a first periodic CSI resource setting comprising a CSI Reference Signal (CSI-RS) resource of periodicity T1 and a second periodic CSI resource setting comprising a CSI-RS resource of periodicity T2 with T1 is larger or equals to T2, when the parameter time Restriction ForChannelMeasurements comprised in the CSI report setting is set to “notConfigured”, the plurality of TRS occasion is selected from a first group of TRS occasion associated with the first CSI resource setting and a second group of TRS occasion associated with the second periodic CSI resource setting, wherein the plurality of TRS occasion is no later than the CSI reference resource, and the first group of TRS occasion is before the second group of TRS occasion; and when the parameter timeRestrictionForChannelMeasurements comprised in the CSI report setting is set to “Configured”, the plurality of TRS comprises a first TRS occasion selected from a group of TRS occasion associated with at least one of the first periodic CSI resource setting and the second periodic CSI resource setting, and a second TRS occasion selected from a group of TRS occasion associated with the second periodic CSI resource setting, wherein the first TRS occasion is before the second TRS occasion, and the plurality of TRS occasion is no later than the CSI reference resource.

In some embodiments, the second TRS occasion is closest to slot n and no later than the CSI reference resource.

In some embodiments, the plurality of TRS occasion is after a last symbol of a Physical Downlink Control Channel (PDCCH) signaling.

In some embodiments, when the CSI report setting is associated with at least one periodic CSI resource setting comprise a CSI-RS resource with a same period, when the parameter timeRestrictionForChannelMeasurements comprised in the CSI report setting is set to “notConfigured”, the plurality of TRS occasion is selected from a group of TRS occasion associated with at least one of the periodic CSI resource setting, wherein the plurality of TRS occasion is no later than the CSI reference resource; when the parameter timeRestrictionForChannelMeasurements comprised in the CSI report setting is set to “Configured”, the plurality of TRS comprises a first TRS occasion and a second TRS occasion that is after the first TRS occasion, wherein the plurality of TRS occasion is selected from a group of TRS occasion associated with at least one of the periodic CSI resource setting, and the plurality of TRS occasion are no later than the CSI reference resource.

In some embodiments, the second TRS occasion is closest to slot n no later than the CSI reference resource.

In some embodiments, the plurality of TRS occasion is after a last symbol of a Physical Downlink Control Channel (PDCCH) signaling.

In some embodiments, the channel correlation is further measured based on parameters Z and Z′ that depend on parameters Z₂, Z₂, wherein Z₂ and Z₂ are determined through checking a pre-defined table.

In some embodiments, Z and Z′ are determined as: Z=Z₂+V. Z′=Z₂+V, wherein V is an integer selected from a set {1, 2, . . . , 100}.

In some embodiments, Z and Z′ are determined as: Z=Z₂+Q. Z′=Z₂+Q, wherein Q is an integer indicating a capability of the wireless device.

In some embodiments, Z and Z′ are determined further based on at least one of: 1) an integer V selected from a set {1, 2., . . . 100}, 2) an integer Q indicating a capability of the wireless device 3) an integer Y indicating a number of amplitudes and/or phases of channel correlations in the time-domain channel property, 4) an integer X indicating a number of slots within a TRS burst or 5) a parameter indicating a delay of a channel correlation.

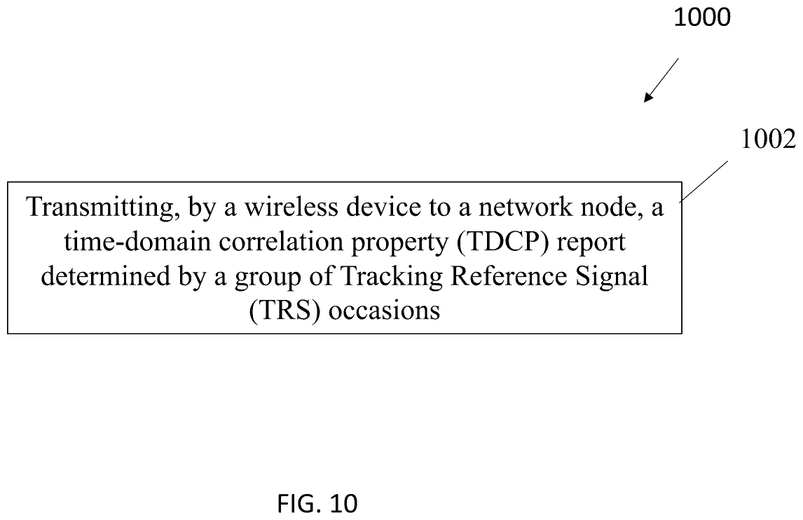

In another example aspect (e.g., as depicted in FIG. 10), another wireless communication method is disclosed. The method includes transmitting (1002), by a wireless device to a network node, a time-domain channel property (TDCP) report determined by a group of Tracking Reference Signal (TRS) occasions.

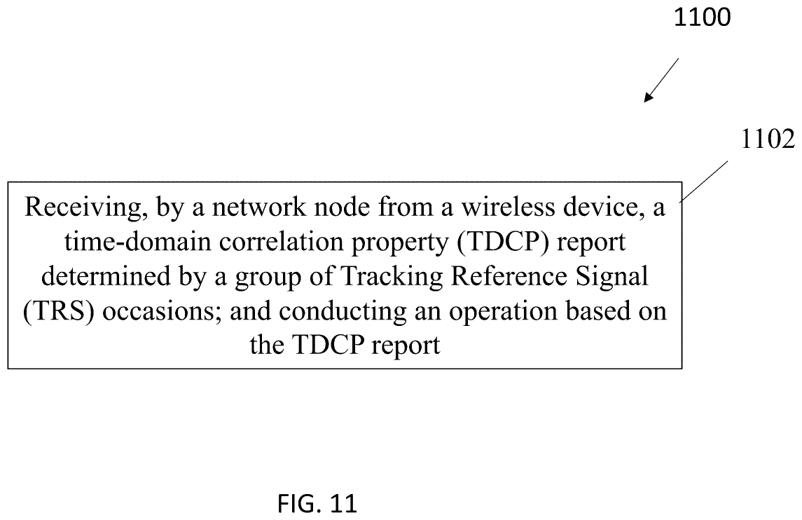

In another example aspect (e.g., as depicted in FIG. 11), another wireless communication method is disclosed. The method includes receiving (1102), by a network node from a wireless device, a time-domain channel property (TDCP) report determined by a group of Tracking Reference Signal (TRS) occasions; and conducting an operation based on the TDCP report.

In some embodiments, the method further comprising: receiving, by a wireless device, a DCI carried on PDCCH triggering a TDCP report; determining, by the wireless device, the TDCP report based on a plurality of TRS occasions; and transmitting, by the wireless device, the TDCP report on PUSCH, to a network device.

In some embodiments, the TDCP report occupies a plurality of CPUs for a continuous time duration from a first symbol of a Physical Downlink Control Channel (PDCCH) signal until a last symbol of a Physical Uplink Shared Channel (PUSCH) that carries the TDCP report.

In some embodiments, the number of the plurality of CPUs is 1.

In some embodiments, number of the plurality of CPUs depends on at least one of K or Y, wherein Y indicates a number of amplitudes of channel correlations included in the TDCP report, wherein K indicates a capability of the wireless device.

In some embodiments, number of the plurality of CPUs depends on at least one of K or M, wherein K indicates a capability of the wireless device, where M indicates number of TRS occasion pairs used to determine channel correlations in a TDCP report.

In some embodiments, number of the plurality of CPUs depends on at least one of K, Y or M, wherein K indicates a capability of the wireless device, wherein M indicates number of TRS occasion pairs used to determine channel correlations in the TDCP, wherein Y indicates Y indicates a number of amplitudes of channel correlations included in the TDCP.

In some embodiments, each of the plurality of TRS occasions occupies a plurality of CPUs for a duration of P consecutive symbols starting from a symbol carrying the TRS occasion.

In some embodiments, P is selected from a set {5, 6, . . . ,20}.

In some embodiments, number the plurality of CPU is 1.

In some embodiments, number the plurality of CPU is K, wherein K indicates a capability of the wireless device.

In some embodiments, each, except a last one, of the plurality of TRS occasion occupies a plurality of CPU for a duration of P consecutive symbols starting from a symbol carrying the TRS occasion.

In some embodiments, P is selected from a set {5, 6, . . . ,20}.

In some embodiments, number of the plurality of CPU is 1.

In some embodiments, number of the plurality of CPU is determined by at least one of K or Y, wherein K indicates a capability of the wireless device, wherein Y indicates a number of amplitudes of channel correlations included in the TDCP report.

In some embodiments, a last one of the plurality of TRS occasion occupies a plurality of CPU for a duration starting from a symbol carrying the TRS occasion until a last symbol of PUSCH carrying the TDCP report.

In some embodiments, number of the plurality of CPU is 1.

In some embodiments, number of the plurality of CPU is determined by at least one of K or Y, wherein K indicates a capability of the wireless device, wherein Y indicates a number of amplitudes of channel correlations included in the TDCP report.

Various preferred embodiments and additional features of the above-described method of FIGS. 8-11. Further examples are described with reference to embodiments 0 to 2.

Under the existing standard, the specific TDCP measurement and reporting procedure, including time restriction and CPU occupation of TDCP reporting, have not been determined yet. The proposed methods are beneficial at least for proposing applicable time restrictions and CPU occupation schemes for TDCP reporting. The systems and methods discussed herein can include processes, procedures, and/or implementations for signaling.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
reporting, by a wireless device, a time-domain channel property to a network device in a time slot n, wherein the time-domain channel property is measured based on a plurality of Tracking Reference Signal (TRS) occasions determined based on 1) a channel state information CSI report setting, or 2) a CSI reference resource.

2. The method of claim 1, further comprising
receiving, by the wireless device, a Downlink Control Information (DCI) indicating the CSI report setting, from the network device, wherein the CSI report setting is associated with a CSI resource setting;
receiving, by the wireless device, TRS, from a network device; and
measuring, by the wireless device, a time-domain channel property comprising at least one of: an amplitude or/and a phase of one or more channel correlations, to the network device, wherein each of the one or more channel correlations is determined based on a plurality of TRS occasion determined based on 1) the CSI report setting, and 2) a CSI reference resource.

3. The method of claim 2, wherein the one or more channel correlations are further measured based on parameters Z and Z′ that depend on parameters Z₂, Z₂, wherein Z₂ and Z₂ are determined through checking a pre-defined table.

4. A method for wireless communication, comprising:
transmitting, by a wireless device to a network node, a time-domain channel property (TDCP) report determined by a group of Tracking Reference Signal (TRS) occasions.

5. The method of claim 4, further comprising:
receiving, by the wireless device, a Downlink Control Information (DCI) carried on a physical downlink control channel (PDCCH) triggering the TDCP report;
determining, by the wireless device, the TDCP report based on a plurality of TRS occasions; and
transmitting, by the wireless device, the TDCP report on physical uplink shared channel (PUSCH), to the network device.

6. The method of claim 5, wherein the TDCP report occupies for a continuous time duration from a first symbol of a Physical Downlink Control Channel (PDCCH) that carries the DCI until a last symbol of a Physical Uplink Shared Channel (PUSCH) that carries the TDCP report.

7. A method for wireless communication, comprising:
receiving, by a network node from a wireless device, a time-domain channel property (TDCP) report determined by a group of Tracking Reference Signal (TRS) occasions; and
performing an operation based on the TDCP report.

8. The method of claim 7, including:
transmitting, by the network node, a Downlink Control Information (DCI) carried on a physical downlink control channel (PDCCH) triggering the TDCP report.

9. The method of claim 8, wherein the TDCP report occupies for a continuous time duration from a first symbol of a Physical Downlink Control Channel (PDCCH) that carries a downlink control information (DCI) until a last symbol of a Physical Uplink Shared Channel (PUSCH) that carries the TDCP report.

10. An apparatus for wireless communication, comprising at least one processor configured to cause the apparatus to implement the method recited in claim 1.

11. An apparatus for wireless communication, comprising at least one processor configured to cause the apparatus to implement the method recited in claim 4.

12. An apparatus for wireless communication, comprising at least one processor configured to cause the apparatus to implement the method recited in claim 7.
